(19) United States
(12) Patent Application Publication
(10) Pub. No.: US 2007/0250681 A1
(43) Pub. Date: Oct. 25, 2007

(54) Independent programmable operation sequence processor for vector processing

(75) Inventors: Thomas A. Horvath, Stormville, NY (US); Thomas McCarthy, Cortland Manor, NY (US)

Correspondence Address: LOUIS PAUL HERZBERG, 3 CLOVERDALE LANE, MONSEY, NY, 10952, US

(73) Assignee: International Business Machines Corporation, Armonk, NY (US)

(21) Appl. No.: 11/401,130

(22) Filed: Apr. 10, 2006

(51) Int. Cl. G06F 15/00

(52) U.S. Cl. 712/4

(57) ABSTRACT

The present invention provides methods, systems and apparatus to control instruction sequencing for a vector processor in a parallel processing environment. It enhances standard Vector Processing architectures by using two independent processing units working in conjunction to produce a highly efficient data processing ensemble. In an example embodiment, the two processors include a Scalar Processor and a separate Vector Processor. The Scalar Processor has its own Instruction Store, General Purpose Registers and Arithmetic Logic Unit. It can execute a standard instruction set including branch and jump instructions. It's function is to control the processing sequence of the Vector Processor. The Vector Processor has an independent Instruction Store, a dedicated Register along with dedicate functional elements to perform vector operations. The Vector Processor does not execute any sequencing instructions such as branch or jump but executes a serial instruction sequence starting and ending at locations determined by the Scalar Processor.

### FIELD OF THE INVENTION

The invention is directed to the field of vector processing. It is more particularly directed to control of instruction sequencing for a vector processor in a parallel processing environment.

### BACKGROUND

A vector processor, array processor, also referred to as a vector computer, is basically a CPU designed to be able to run mathematical operations on multiple data elements simultaneously. This is in contrast to a scalar processor which handles one element at a time. The vast majority of CPUs are scalar (or close to it). Vector processors were common in the scientific computing area, where they formed the basis of most supercomputers through the 1980s and into the 1990s, but general increases in performance and processor design saw the near disappearance of the vector processor as a general-purpose CPU. Today almost all commodity CPU designs include some vector processing instructions, typically known as Single Instruction, Multiple Data machines. Computer graphics hardware and video game consoles rely heavily on vector processors in their architecture.

A vector processor is basically a machine designed to efficiently handle arithmetic operations on elements of arrays, called vectors. Such machines are especially useful in high-performance scientific computing, where matrix and vector arithmetic are quite common. The vector processor can operate on an entire vector in one instruction. Generally, a vector processor includes a set of special arithmetic units called pipelines. Pipelines overlap the execution of the different parts of an arithmetic operation on the elements of the vector, producing a more efficient execution of the arithmetic operation. This heavily pipelined architecture is exploited using operations on vectors and matrices. Data is read into the vector registers capable of holding a large number of floating point values and the processor performs operations on all elements in the vector register.

Vector processors are primarily built to handle large scientific and engineering calculations, which exhibit large amounts of data-level-parallelism. The instructions in a vector processor have a higher semantic contents, because they use a single instruction to include all the operations normally coded using a loop; and they offer higher performance because all the operations on a vector instruction can be performed in parallel.

Vector processors work well with numeric regular codes where vector capabilities can be exploited. Numeric regular codes are those which contain loops with independent iterations. However, numeric non-regular codes or generic integer codes can't get benefit from this kind of technology because their operations are not data-parallel. Vector processor architecture is advantageous for compute-intensive applications like multimedia or cryptographic codes. Similar technologies used in classical vector processors are now used in modern processors to deliver higher microprocessor hardware performance. These kinds of codes have vectorizable capabilities.

Some vector processors include vector registers. A general purpose or a floating-point register holds a single value; vector registers contain several elements of a vector at one time. Contents of these registers may be sent to and/or received from a vector pipeline one element at a time. Some vector processors include scalar registers which behave like general purpose or floating-point registers. These registers hold a single value. However, these registers are configured so that they may be used by a vector pipeline; the value in the register is read once every interval unit of time and put into the pipeline, just as a vector element is released from the vector pipeline. This allows the elements of a vector to be operated on by a scalar. For typical vector architectures, the value of ‘tau’, the interval unit of time to complete one pipeline stage, is equivalent to one clock cycle of the machine. On some machines, it may be equal to two or more clock cycles. Once a pipeline is filled, it generates one result for each ‘tau’ units of time, that is, for each clock cycle. This means the hardware performs one floating-point operation per clock cycle.

Typical Vector Processor architectures contain both vector instructions for data processing and scalar instructions for the sequencing of process tasks. As used herein a vector instruction is a instruction that employs processing of an instruction by a family of vector processors performed in parallel by the family of processors. Vector data processing instructions include vector arithmetic, logical, multiply and multiply accumulate instructions. A scalar instruction is an instruction that employs a serial process [usually] performed by only one processor of the family of processors. Scalar instructions include instructions of sequencing, jump, branch, and compare type instructions.

It is noted that in order to improve processing performance in environments where multiple processing tasks can be performed in parallel various multiprocessor architectures can be utilized. One class of multiprocessor architectures is a Single Instruction Multiple Data (SIMD) arrangement also known as Vector Processor. This implies that the same processing task can be performed on multiple data entities simultaneously. One class of applications that can benefit from his type of processing deals with image processing. Image processing can range from color conversion, filtering, compression/decompression among many other algorithms which involve simultaneously processing multiple independent picture elements (pixels) using a Vector Processor.

There are several methods used for implementing Vector Processors. One method is to extend the base architecture of a standard processor by replicating part of its core processing elements and adding special instructions which allows multiple data elements to be processed in these units simultaneously. Another method, which is addressed by this invention is to develop a Vector Processor as a coprocessor to the main processor also known as the Host Processor. The Vector Coprocessor operates on large amounts of data independently from the Host Processor which is used to set up tasks for the Vector Coprocessor to perform. The Vector Coprocessor has its own set of instructions, storage units, processing elements, sequencer and mechanism to access the Main Store through a system Bus which is in common with the Host Processor. Information about what tasks to perform on what data, is passed to the Vector Processor by the

Host Processor through a series of Control Blocks which are located in the Main Store. Once a task or series of tasks are assembled by the Host Processor, the Host Processor initializes the Vector Coprocessor by first loading an initialization program into the Vector Coprocessors Instruction Store and then generating an interrupt to the Vector Coprocessor to begin processing the first task. The Vector Coprocessor reads the first Control Block from System Memory, interprets the operation to be performed. The Vector Coprocessor then loads the required program into the Instruction Store and data to be processed into the Data Store and begins execution of the task. When the task is completed the Vector Coprocessor stores the results back to Main Store and loads the next data to be processed into the Data Store and begins processing the current data. The store, load and processing steps are repeated until all of the data has been processed. The Vector Coprocessor then reads the next Control Block from Main Store to determine what the next task it must perform. All of the previous steps of reading the program and data and storing the results are repeated for the current task. The process of fetching control blocks and performing the designated task upon the specified data is repeated until all of the Control Blocks are processed. At the completion of the Control Block processing the Vector Coprocessor interrupts the Host Processor to indicate that all of the specified tasks have been completed thus ending the operation.

An aspect of a Vector Coprocessor is to process as much data as possible in the shortest amount of time. Since Vector Coprocessors come at a cost to the overall system implementation it is desirable to achieve the maximum utilization of the Coprocessor both in performance and hardware resources. Since Vector Coprocessors are limited to certain types of applications but not fixed to a specific set, it is also desirable to make them flexible enough to allow them to be used in as many environments as possible. The Vector Coprocessor in the above description is responsible for both executing control programs as well as performing data processing programs. The control programs are composed of serial instructions consisting of decision making operations as well as branch and jump instructions executed in a sequential manner. The data processing programs are composed of vector instructions operating on multiple data elements. They do not contain branch or jump instructions.

Typical implementations for Vector Coprocessors combine both types of processing capabilities into a single structure. This means that the processor can execute both scalar and vector instructions and can operate on both vector and scalar data using vector registers for data store. There are several limitations in this type of organization. One limitation is that the control processing and data processing tasks have to be performed sequentially. This means that the processor is not being utilized fully for data processing while it is setting up for the next task and saving the results from the previous task. Another disadvantage is that the data store registers are under utilized when they contain scalar information because the remaining portion of the vector register is unused.

There are also implementations for Vector Coprocessors where the control sequencing is and fixed in dedicated hardware. The disadvantage of these implementations is that they limit the Vector Coprocessors usability and also require that the Host Processor be more closely coupled to the Vector Coprocessor to initiate and execute tasks. This impacts the utilization of the Host Processor.

Scalar processing instructions are often merged with the vector processor resources such as registers, arithmetic logical units, instruction store and general data flow structures. This architectural merge between the two types of processors tends to draw away from the processing capabilities of the Vector processor for both execution time and hardware resources thereby reducing the throughput and efficiency of the Vector unit. Typically the, scalar and vector operations of processes are independent of each other and therefore do not require a combined structure. Consequently it is would be advantageous to have a means to increase data processing capabilities of a Vector processor by separating out the scalar instructions such as sequence processing instructions, into a separate engine. Architectures used in other implementations, containing some sequencing operations such as loop commands, involve dedicated hardware with a limited and fixed set of operations that can be used to control the sequence processing of a Vector processor. These type of architectures are very limited to a specific system environment and a set of applications. By allowing the sequence processing unit to be fully programmable it can be adapted to most environments and the entire structures capability can be extended for a more varied set of applications.

FIG. 1 shows a typical Vector Co-Processor (VCP) architecture. It shows Host Processor 100 and System Memory 101 bidirectionally coupled to System Bus 102. The System Bus 102 in turn couples to the Vector Co-Processor 103. The Vector Co-Processor 103 includes: Data Mover 104 coupled to VP/SP Instruction Store 105 and VP/SP Data Store 106. VP/SP Instruction Store 105 couples to Vector/Scalar Processor 107. VP/SP Data Store 106 also couples to Vector/Scalar Processor 107. Typically, Vector/Scalar Processor 107 handles all processing functions. This causes inefficient and time consuming processing.

When vector and scalar operations are embodied in one processor without overlapping, Sequence Processor operation are performed within the Vector Processor as follows:
digitized image loaded into system memory;
define processing problem to be performed on the image;
host loads Vector Processor memory;
host processor breaks tasks into sub-tasks across entire image;
it sets up one or more control blocks to tell the Vector Processor what tasks to perform;
host generates an interrupt to Sequence Processor to tell it to start and where to start;
the Vector Processor fetches the CB and interprets task to perform;
the Vector Processor uses Data Mover to load Vector Processor instruction store;
the Vector Processor pre-loads the first block to be processed; and
vector Processor starts processing.

The Vector Processor executes the process for the first block. The Vector Processor stores the first block to memory. The Vector Processor loads the next block to be executed. The Vector Processor processes the second block. The Vector Processor stores the second block

Some implementations operate as follows:
digitized image loaded into system memory;
define processing problem to be performed on the image;
host loads Sequence Processor memory;
host processor breaks tasks into sub-tasks across entire image;
it sets up one or more control blocks to tell the Sequence Processor what tasks to perform;
host generates an interrupt to Sequence Processor to tell it to start and where to start;
the Vector Processor fetches the CB and interprets task to perform;
the Vector Processor uses Data Mover to load Vector Processor instruction store;
the Vector Processor pre-loads the first block to be processed; and
Vector Processor starts processing.

SUB-BLOCK Processing assuming m tasks on n sub-block is performed as follows:
Vector Processor sets up to perform task 1 on Sub block 1,
Vector Processor performs task 1 on sub block 1,
Vector Processor sets up to perform task 1 on Sub block 2,
Vector Processor performs task 1 on sub block 2,
Vector Processor sets up to perform task 1 on Sub block n,
Vector Processor performs task 1 on sub block n,
Vector Processor sets up to perform task 2 on Sub block 1,
Vector Processor performs task 2 on sub block 1,
Vector Processor sets up to perform task 2 on Sub block 2,
Vector Processor performs task 2 on sub block 2,
Vector Processor sets up to perform task 1 on Sub block n,
Vector Processor performs task 2 on sub block n,
Vector Processor sets up to perform task m on Sub block 1,
Vector Processor performs task m on sub block 1,
Vector Processor sets up to perform task m on Sub block 2,
Vector Processor performs task m on sub block 2,
Vector Processor sets up to perform task 1 on Sub block n, and,
Vector Processor performs task m on sub block n.

The Sequence Processor pre-loads second block to be processed and waits for first block to be finished. When the 1st block is finished the Sequence Processor tell Vector Processor to process second block. The Sequence Processor save results from first in MS. The Sequence Processor tells Data Mover to pre-load next block. Thus, the Vector Processor handles all processing functions. This causes inefficient and time consuming processing.

### SUMMARY

It is therefore an aspect of the present invention to provide methods, apparatus, architecture and systems for enhancing standard Vector Processing architectures by using two independent processing units working in conjunction to produce a highly efficient data processing ensemble. In an example embodiment, the two processors include a Scalar Processor (SP) and a separate Vector Processor (VP). The SP is a standard processor with its own Scalar Processor Instruction Store (SPIS), Scalar Processor General Purpose Registers (SPGPR) and Scalar Processor Arithmetic Logic Unit (SPALU). It can execute a standard instruction set including branch and jump instructions. It's primary function is to control the processing sequence of the Vector Processor. The VP has an independent Vector Processor Instruction Store (VPIS), a dedicated Vector Processor General Purpose Register (VPGPR) along with dedicate functional elements to perform vector operations.

In this embodiment, the VP does not execute any sequencing instructions such as branch or jump but executes a serial instruction sequence starting and ending at locations determined by the SP. Control information from the SP to the VP is passed through a command queue which is read and executed by the VP sequencer. The command queue would typically contain starting and ending addresses but may also contain pertinent information needed by the VP to execute the desired sequence. By separating the Sequencing from the Data Processing tasks and allowing them to execute simultaneously the overall system gains in efficiency because in this mode the VPs utilization can achieve 100% for most algorithms. This results because most algorithms can be broken up into several tasks which can be queued up by the SP for the VP to process. In addition, this form of an architecture allows the SP to control the movement of data into and out of the VPs data storage completely overlapping with the VPs execution.

### BRIEF DESCRIPTION OF THE DRAWINGS

FIG. 1 shows the block diagram of a standard vector processing environment; and

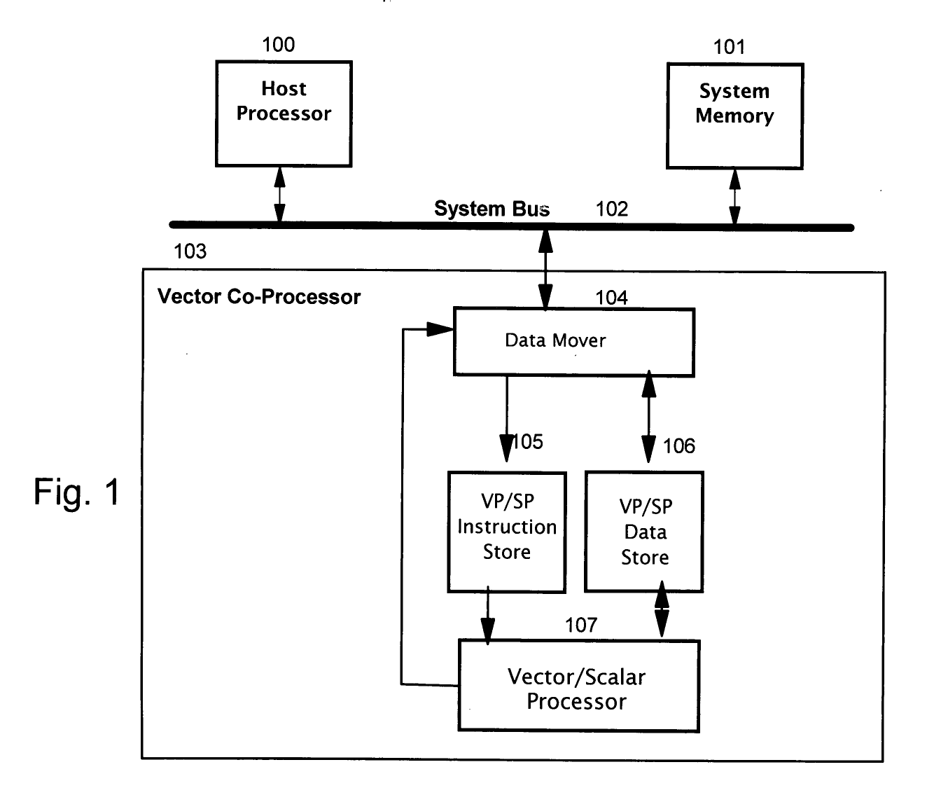

FIG. 2 shows the block diagram a a series-parallel processing environment with separate Vector and Scalar processors in accordance with the present invention.

### DESCRIPTION OF THE INVENTION

The present invention provides methods, apparatus, architecture and systems for enhancing standard Vector Processing architectures by using [at least] two independent processing units working in conjunction to produce a highly efficient data processing ensemble.

In an example embodiment of the present invention, the independent processing units include two processors, a Scalar Processor (SP) and a separate Vector Processor (VP). The SP is a standard processor with its own Scalar Processor Instruction Store (SPIS), Scalar Processor General Purpose Registers (SPGPR) and Scalar Processor Arithmetic Logic Unit (SPALU). It can execute a standard instruction set including branch and jump instructions. It's primary function is to control the processing sequence of the Vector Processor. The VP has an independent Vector Processor Instruction Store (VPIS), a dedicated Vector Processor General Purpose Register (VPGPR) along with dedicate functional elements to perform vector operations.

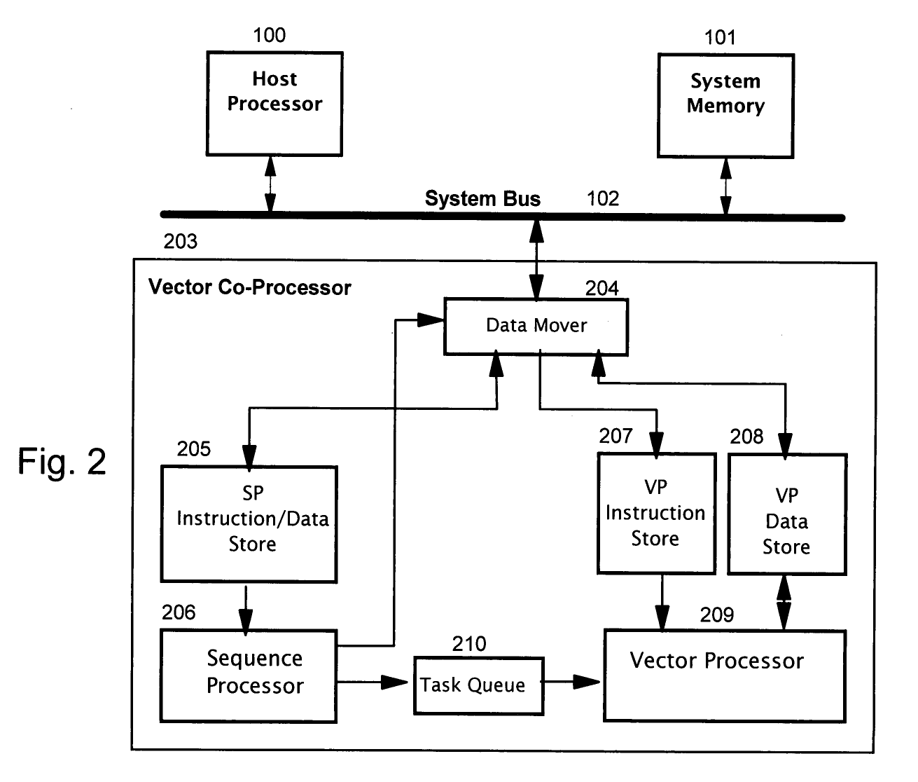

The embodiment is shown in FIG. 2. FIG. 2 shows a Vector Co-Processor (VCP) architecture in accordance with the present invention. Here again, Host Processor 100 and System Memory 101 are coupled to System Bus 102. However here, System Bus 102 is coupled to a novel Vector Co-Processor 203. Vector Co-Processor 203 includes Data Mover 204 coupled to SP Instruction/Data Store 205, VP Instruction Store 207, and VP Data Store 208. VP Instruction Store 207 and VP Data Store 208 are coupled to Vector Processor 209. SP Instruction/Data Store 205 is coupled to Sequence Processor 206. Sequence Processor 206 is coupled to Task Queue 210. Task Queue 210 is coupled to Vector Processor 209. Sequence Processor 206 is coupled to Data Mover 204.

In this embodiment, the Vector Processor 209 does not execute any sequencing instructions, such as branch or jump, but executes serial instruction sequences starting and ending at locations determined by the Scalar Processor 206. Control information from the Scalar Processor 206 to the Vector Processor 209 is passed through a command queue which is read and executed by the VP sequencer. The command queue would typically include starting and ending addresses but may also include pertinent information needed by the Vector Processor 209 to execute the desired sequence. By separating the Sequencing from the Data Processing tasks and allowing them to execute simultaneously the overall system gains in efficiency because in this mode the Vector Processor's utilization can achieve 100% for most algorithms. This results because most algorithms can be broken up into several tasks which can be queued up by the Scalar Processor 206 for the Vector Processor 209 to process. In addition, this form of an architecture allows the Scalar Processor 206 to control the movement of data into and out of the Vector Processor's data storage completely overlapping with the Vector Processor's execution.

The desired goals of maximum utilization at a minimum cost of the Vector Coprocessor 203 can be achieved by separating the control and data processing portions of the Vector Coprocessor into two independent processors each optimized to perform its function with the maximum efficiency. One processor, the Sequence Processor 206 is designed to execute its function most efficiently by limiting both its instruction set and its data storage elements. Its instruction set only needs to execute the simple logical and arithmetic operations for maintaining sequencing information and branch and jump instructions for decision making processing. For example, it does not need a multiply operation thereby saving space. Its registers are all scalar and can be limited in size.

The second processor is the Vector Processor 209 which is optimized to process only vector instructions and includes only vector registers. It does not process any scalar instructions including branch or jump instructions. Both processors have their own Instruction Store and both can operate simultaneously. The Sequence Processor's task is to interpret control block from the Host Processor and based on the desired action to load and initiate various tasks that the Vector Processor needs to perform. The Sequence Processor 206 is also responsible for controlling the Data Mover 204 to move data from System Memory to the Vector Processors Data Store and to move the resulting processed data back to System Memory. The Sequence Processor 206 does not process any of the data designated for the Vector Processor therefore it is free to perform its tasks while the Vector Processor is busy processing its task.

The Sequence Processor 206 is responsible for setting up tasks for the Vector Processor through a Task Queue 210 buffer. Task Queue 210 is a hardware queue which can hold several tasks that the Vector Processor needs to perform. The definition of a task is simply a starting and ending address that the Vector Processor needs to execute from and to in its Instruction Store. Since the Vector Processor does not include any branch or jump instructions the task sequence will always increment from start to end address. Various parameters can be passed to the Vector Processor which can be used to initialize certain Vector Processor configurations for each task. These parameters are specific to the Vector Processor design and it is not within the scope of this patent to define all possible implementations. However, as an example, in the case that the Data Store of the Vector Processor is configured into multiple banks, a pointer to which bank the data can be found in for the specified task can be passed. Also the Sequence Processor 206 can monitor the progress of the Vector Processor based on how many tasks are left in the Task Queue. When the Task Queue is empty the Vector Processor remains idle. When there is at least one task in the Task Queue the Vector Processor begins processing at the starting address in its Instruction Store. The Sequence Processor 206 can be allowed access to various registers and status information of the Vector Processor but this is also implementation dependent and not within the scope of this patent to list in detail. Other implementation dependent values include the depth of the Task Queue which determines how many task may be queued up for the Vector Processor. One possible number is 16 tasks but any other value can be implemented.

This separation of the two processors allows for full overlapping of the control and data processing within the Vector Coprocessor complex. It also allows the Vector Coprocessor to operate independently from the Host Processor which provides for a greater potential for high system level utilization then in other coprocessor environments. Since the Sequence and Vector Processors are each optimized to their specific tasks and allowed to operate independently, the objective of providing maximum utilization in both hardware complexity and performance can be realized.

It is noted that the present invention provides many advantages. These include:
allows overlapping of data transfer control and execution of vector processor;
allows the customization of system level processing control;
allows the emulation of chained control block processing environment;
allows modification to control block architecture through software upgrade; and
uses a task queue to set the Vector Processor up for multiple back to back tasks, (replaces branch/jump operations).

Task queue 210 includes start and end addresses for each tack to be performed. The vector processor sits idle until there is a task written into the Task Queue. If the Task Queue is not empty it begins operation at the Start address in the Task Queue when it reaches the End Address it gets the next task Start Address if there is a task in the Task Queue. It continues this until the Task Queue is empty. In addition to the Start and End Addresses certain Task Initialization parameters can be passed to the Vector Processor such as Base Address or Initialization Data.

Sequence Processor 206 sets the Data Mover 204 to transfer data in and out of the VP memory/registers to save the results of a previous task and prepare it for the next task. The SP can monitor the status of the VP based on the Task Queue being empty.

Vector processor 209 is tailored to execute vector operations efficiently. The instruction set is geared for simple execution of logical and arithmetic operations. The pipeline is designed for maximum efficiency to complete one operation in every cycle. The objective in a vector processing environment is to maintain a high rate of utilization of the vector processor. Decision making operations are not inherently easy to execute on vector processors. They interrupt the dataflow and reduce the efficiency of the vector unit. Scalar operations executed on a vector unit also reduce the efficiency of the overall processing since the only one processor is active during each scalar operation.

Using the Host Processor 100 ties it up if it is relying on polling and creates too much latency if interrupts are used. Having a dedicated scalar processor allows the Vector environment to run independently from the Host for an extended period. The scalar processor only monitors the Vector processor for completion and prepares it for the next task.

Thus the present invention includes a Vector Coprocessor apparatus and architecture. In an embodiment, the Vector Coprocessor is coupled to a Host Processor on a System Bus. and to a System Memory providing storage used to hold data to be processed and control block information of the overall task. The Host Processor setting up an overall task to be performed satisfying a user requirement. The Vector Coprocessor comprising: a Data Mover unit coupled to the System Bus and being used to move data and control block information to and from System Memory and the Vector Coprocessors Local Memory; a Sequence Processor used to communicate with the Host Processor and to control the Data Mover and obtain instructions and data from System Memory to be loaded into Local Memory; a Sequence Processor Instruction/Data Store used to hold the program and control block information for the Sequence Processor; a Vector Processor used to process the image data stored in System Memory; a Vector Processor Instruction Store which hold the program to be executed by the Vector Processor and which is loaded by the Data Mover under the control of the Sequence Processor; a Vector Processor Data Store loaded by the Data Mover containing partial image data from System Memory as well as the results of the Vector Processors processed data to be stored to the System Memory by the Data Mover under the control of the Sequence Processor; and a Task Queue buffer used by the Sequence Processor to set up a sequence of tasks to be performed by the Vector Processor.

In some embodiments, the Data Mover comprises means to move data between the System Memory via the System Bus to local memory with the data including at least one of: instructions, control blocks, and data, and/or the Sequence Processor comprises means to communicate with the System Processor and means to control the sequencing of data transfers and process execution performed by the Vector Coprocessor, and/or the Vector Processor Instruction Store comprises means to store instructions to be executed by the Vector Processor loaded from System Memory by the Data Mover, and/or the Vector Processor Data Store comprises means for storing partial image data loaded from System Memory by the Data Mover, and storing processed data loaded in System Memory, and/or the Vector Processor comprises means for executing instructions stored in the Vector Processor Instruction Store to perform at least one task upon partial image data stored in the Vector Processor Data Store and means for storing resultant processed data back to the Vector Processor Data Store, and/or the Task Queue buffer allows setting up Vector Processor sequential tasks, each of the sequential tasks comprises means for telling the Vector Processor a beginning address in the Vector Processor Instruction Store to begin executing the each sequential task, and a stopping address to stop executing the each sequential task, and includes for the each sequential task to be executed a buffer including configuration information necessary for the Vector Processor to properly execute the each sequential task.

In some embodiments, the task is an image application, and further comprising processing means to process the image application, and the Host Processor loads Sequence Processor Instruction Store with initial program, the Host Processor breaks the overall task into sub-tasks to be performed across an entire image, the Host Processor sets up at least one control block to tell the Sequence Processor particular tasks to perform on the image; the Host Processor generates an interrupt to the Sequence Processor to tell it to start processing at a starting address; the Sequence Processor fetches a first Control Block and interprets a specific task to be performed; the Sequence Processor uses the Data Mover to load the Vector Processor Instruction Store with the appropriate program to perform the task; the Sequence Processor loads the first block of data into the Vector Processor Data Store to be processed; and the Sequence Processor loads the Vector Processor Task Queue tells Vector Processor to start processing.

In some embodiments of the Vector Coprocessor apparatus, the apparatus performs processing of sub tasks. In this case; the Sequence Processor sets up to perform task 1 on Sub block 1 and tells Vector Processor to start processing; the Sequence Processor sets up to perform task 1 on Sub block 2 and loads task queue as the Vector Processor continues to process; the Sequence Processor sets up to perform task 1 on Sub block n and loads task queue as the Vector Processor continues to process; the Sequence Processor sets up to perform task 2 on Sub block 1 and tells Vector Processor to start processing; the Sequence Processor sets up to perform task 2 on Sub block 2 and loads task queue as the Vector Processor continues to process; the Sequence Processor sets up to perform task 2 on Sub block n and loads task queue as the Vector Processor continues to process; the Sequence Processor sets up to perform task m on Sub block 1 and tells Vector Processor to start processing; the Sequence Processor sets up to perform task m on Sub block 2 and loads task queue as the Vector Processor continues to process; and the Sequence Processor sets up to perform task m on Sub block n and loads task queue as the Vector Processor continues to process.

The present invention also includes a method comprising separately processing for an overall task a scalar sub-task including scalar instructions and a vector sub-task including vector instructions, the step of processing comprising: providing an environment having a first processor with a first program of the vector instructions dedicated to data processing; providing a second processor having a second program of the scalar instructions dedicated to sequencing tasks for the first processor, and controlling movement of data from system memory to and from the first and second processors; providing a sequence of the vector sub-tasks for the vector instructions executed by the first processor, including in the scalar instructions, instructions necessary in decision making for controlling process sequencing of the first processor by the second processor, including in the vector instructions, instructions necessary for processing data in a vectorized manner in the first processor, and providing buffer queuing for controlling interaction of the scalar sub-task and the vector sub-task for the overall task.

In some embodiments of the method the vector instructions include at least one instruction taken from a group of vector instructions including: vector add, vector subtract, vector multiply, vector divide, and a vector logical instruction, and/or the scalar instructions include at least one instruction taken from a group of instructions including: compare, logical, branch and jump instructions. and instructions necessary for maintaining counting information such as arithmetic add and subtract instructions; and/or the overall task is an image application, and further comprising processing the image application, the step of processing the image application comprising: a Host Processor loading a Sequence Processor Instruction Store with an initial program, the Host Processor breaking the overall task into sub-tasks to be performed across an image, the Host Processor setting up at least one control block to tell the Sequence Processor particular tasks to perform on the image; the Host Processor generating an interrupt to the Sequence Processor to tell it to start processing a control block located at a specified starting address in System Memory; the Sequence Processor fetching a first control block and interpreting a specific task to be performed; the Sequence Processor using a Data Mover to load a Vector Processor Instruction Store with an appropriate program to perform the specific task; the Sequence Processor using the Data Mover to load a first block of data into the Vector Processor Data Store to be processed; and the Sequence Processor loading the Vector Processor Task Queue with parameters necessary to tell the Vector Processor to start processing.

Variations described for the present invention can be realized in any combination desirable for each particular application. Thus particular limitations, and/or embodiment enhancements described herein, which may have particular advantages to a particular application need not be used for all applications. Also, not all limitations need be implemented in methods, systems and/or apparatus including one or more concepts of the present invention. Methods may be implemented as signal methods employing signals to implement one or more steps. Signals include those emanating from the Internet, etc.

The present invention can be realized in hardware, software, or a combination of hardware and software. A visualization tool according to the present invention can be realized in a centralized fashion in one computer system, or in a distributed fashion where different elements are spread across several interconnected computer systems. Any kind of computer system—or other apparatus adapted for carrying out the methods and/or functions described herein—is suitable. A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which—when loaded in a computer system—is able to carry out these methods.

Computer program means or computer program in the present context include any expression, in any language, code or notation, of a set of instructions intended to cause a system having an information processing capability to perform a particular function either directly or after conversion to another language, code or notation, and/or reproduction in a different material form.

Thus the invention includes an article of manufacture which comprises a computer usable medium having computer readable program code means embodied therein for causing a function described above. The computer readable program code means in the article of manufacture comprises computer readable program code means for causing a computer to effect the steps of a method of this invention. Similarly, the present invention may be implemented as a computer program product comprising a computer usable medium having computer readable program code means embodied therein for causing a a function described above. The computer readable program code means in the computer program product comprising computer readable program code means for causing a computer to effect one or more functions of this invention. Furthermore, the present invention may be implemented as a program storage device readable by machine, tangibly embodying a program of instructions executable by the machine to perform method steps for causing one or more functions of this invention.

It is noted that the foregoing has outlined some of the more pertinent objects and embodiments of the present invention. This invention may be used for many applications. Thus, although the description is made for particular arrangements and methods, the intent and concept of the invention is suitable and applicable to other arrangements and applications. It will be clear to those skilled in the art that modifications to the disclosed embodiments can be effected without departing from the spirit and scope of the invention. The described embodiments ought to be construed to be merely illustrative of some of the more prominent features and applications of the invention. Other beneficial results can be realized by applying the disclosed invention in a different manner or modifying the invention in ways known to those familiar with the art.

What we claim is:

1. A Vector Coprocessor apparatus coupled to a Host Processor on a System Bus, said Host Processor setting up an overall task to be performed satisfying a user requirement, and coupled to a System Memory providing storage used to hold data to be processed and control block information of said overall task, said Vector Coprocessor apparatus comprising:
a Data Mover unit coupled to said System Bus and being used to move data and control block information to and from System Memory and the Vector Coprocessor's Local Memory;
a Sequence Processor for processing scalar instructions and being used to communicate with said Host Processor and to control said Data Mover and obtain instructions an(. data from System Memory to be loaded into Local Memory;
a Sequence Processor Instruction/Data Store used to hold the program and control block information for the Sequence Processor;
a Vector Processor for processing vector instructions and vector data and for processing data stored in System Memory;
a Vector Processor Instruction Store which holds the program to be executed by the Vector Processor and which is loaded by the Data Mover under the control of the Sequence Processor;
a Vector Processor Data Store loaded by the Data Mover containing partial application data from System Memory as well as the results of the Vector Processors processed data to be stored to the System Memory by the Data Mover under the control of the Sequence Processor; and
a Task Queue buffer used by the Sequence Processor to set up a sequence of tasks to be performed by the Vector Processor.

2. A Vector Coprocessor apparatus as recited in claim 1, wherein said overall task is a task taken from a group of tasks consisting of:
a digitized image data stream loaded into system memory to be processed in the manner of filtering or scaling or compressing;
a compressed image or video data stream to be decompressed;
a video data stream loaded into system memory to be processed in the manner of filtering or scaling or compressing,
a compressed image or video data stream to be decompressed;
a digitized audio data stream to be processed;
a compressed audio stream to be decompressed;
a task that benefits from use of a vectorized multiprocessor complex;
an application that benefits from use of the vectorized multiprocessor complex; and
data that benefits from use of the vectorized multiprocessor complex.

3. A Vector Coprocessor apparatus as recited in claim 1, wherein the Data Mover comprises means to move data between the System Memory via the System Bus to any local memory with the data including at least one of: instructions, control blocks, and data.

4. A Vector Coprocessor apparatus as recited in claim 1, wherein the Sequence Processor comprises means to communicate with the System Processor, and means to control the sequencing of data transfers and process execution performed by the Vector Coprocessor.

5. A Vector Coprocessor apparatus as recited in claim 1, wherein the Vector Processor Instruction Store comprises means to store instructions to be executed by the Vector Processor loaded from System Memory by the Data Mover.

6. A Vector Coprocessor apparatus as recited in claim 1, wherein the Vector Processor Data Store comprises means for storing partial data loaded from System Memory by the Data Mover, and means for storing processed data loaded into System Memory.

7. A Vector Coprocessor apparatus as recited in claim 1, wherein the Vector Processor comprises means for executing instructions stored in the Vector Processor Instruction Store to perform at least one task upon partial data stored in the Vector Processor Data Store, and means for storing resultant processed data back to the Vector Processor Data Store.

8. A Vector Coprocessor apparatus as recited in claim 1, wherein the Task Queue buffer allows setting up Vector Processor multiple sequential tasks, each task entry of said sequential tasks comprises means for telling the Vector Processor a beginning address in the Vector Processor Instruction Store to begin executing said task, and a stopping address to stop executing said task, and includes for said task to be executed a buffer, said buffer including configuration information necessary for the Vector Processor to properly execute said task.

9. A Vector Coprocessor apparatus as recited in claim 1, wherein the task is an image application, and further comprising processing means to process said image application, wherein:
said Host Processor loads Sequence Processor Instruction Store with an initial program.
said Host Processor breaks said overall task into sub-tasks to be performed across an entire image;
said Host Processor sets up at least one control block to tell the Sequence Processor particular tasks to perform on the image;
said Host Processor generates an interrupt to the Sequence Processor to tell it to start processing a control block located at a specified starting address in System Memory;
said Sequence Processor fetches a first control block and interprets a specific task to be performed;
said Sequence Processor uses the Data Mover to load the Vector Processor Instruction Store with an appropriate program to perform the specific task;
said Sequence Processor uses the Data Mover to load a first block of data into the Vector Processor Data Store to be processed; and
said Sequence Processor loads the Vector Processor Task Queue with parameters necessary to tell the Vector Processor to start processing.

11. A Vector Coprocessor apparatus as recited in claim 1, wherein couplings and interconnection of elements of the Vector Coprocessor apparatus define a Coprocessor architecture.

12. A method comprising separately processing for an overall task a scalar sub-task including scalar instructions and a vector sub-task including vector instructions, said step of processing comprising:
providing an environment having a first processor with a first program of said vector instructions dedicated to data processing;
providing a second processor having a second program of said scalar instructions dedicated to sequencing tasks for the first processor, and controlling movement of data from system memory to and from said first and second processors;
providing a sequence of the vector sub-tasks for said vector instructions executed by the first processor;
including in said scalar instructions, instructions necessary in decision making for controlling process sequencing of the first processor by the second processor;
including in said vector instructions, instructions necessary for processing data in a vectorized manner in said first processor; and
providing buffer queuing for controlling interaction of said scalar sub-task and said vector sub-task for said overall task.

13. A method as recited in claim 12, wherein said vector instructions includes at least one instruction taken from a group of vector instructions including: vector add, vector subtract, vector multiply, vector divide, and a vector logical instruction.

14. A method as recited in claim 12, wherein said scalar instructions includes at least one instruction taken from a group of instructions including: compare, logical, branch and jump instructions. and instructions necessary for maintaining counting information such as arithmetic add and subtract instructions

15. A method as recited in claim 12, wherein the overall task is an image application, and further comprising processing said image application, the step of processing said image application comprising:
a Host Processor loading a Sequence Processor Instruction Store with an initial program.
said Host Processor breaking said overall task into sub-tasks to be performed across an image;
said Host Processor setting up at least one control block to tell the Sequence Processor particular tasks to perform on the image;
said Host Processor generating an interrupt to the Sequence Processor to tell it to start processing a control block located at a specified starting address in System Memory;
said Sequence Processor fetching a first control block and interpreting a specific task to be performed;
said Sequence Processor using a Data Mover to load a Vector Processor Instruction Store with an appropriate program to perform the specific task;
said Sequence Processor using the Data Mover to load a first block of data into the Vector Processor Data Store to be processed; and
said Sequence Processor loading the Vector Processor Task Queue with parameters necessary to tell the Vector Processor to start processing.

16. An article of manufacture comprising a computer usable medium having computer readable program code means embodied therein for causing separate processing for an overall task a scalar sub-task including scalar instructions and a vector sub-task including vector instructions, the computer readable program code means in said article of manufacture comprising computer readable program code means for causing a computer to effect the steps of claim 12.

17. A program storage device readable by machine, tangibly embodying a program of instructions executable by the machine to perform method steps for separately processing for an overall task a scalar sub-task including scalar instructions and a vector sub-task including vector instructions, said method steps comprising the steps of claim 12.

18. A computer program product comprising a computer usable medium having computer readable program code means embodied therein for causing functions of a Vector Coprocessor apparatus coupled to a Host Processor on a System Bus, said Host Processor setting up an overall task to be performed satisfying a user requirement, and coupled to a System Memory providing storage used to hold data to be processed and control block information of said overall task, the computer readable program code means in said computer program product comprising computer readable program code means for causing a computer to effect the functions of:
a Data Mover unit coupled to said System Bus and being used to move data and control block information to and from System Memory and the Vector Coprocessor's Local Memory;
a Sequence Processor for processing scalar instructions and being used to communicate with said Host Processor and to control said Data Mover and obtain instructions and data from System Memory to be loaded into Local Memory;
a Sequence Processor Instruction/Data Store used to hold the program and control block information for the Sequence Processor;
a Vector Processor for processing vector instructions and vector data and for processing data stored in System Memory;
a Vector Processor Instruction Store which holds the program to be executed by the Vector Processor and which is loaded by the Data Mover under the control of the Sequence Processor;
a Vector Processor Data Store loaded by the Data Mover containing partial application data from System Memory as well as the results of the Vector Processors processed data to be stored to the System Memory by the Data Mover under the control of the Sequence Processor; and
a Task Queue buffer used by the Sequence Processor to set up a sequence of tasks to be performed by the Vector Processor.

19. A computer program product as recited in claim 18, wherein the task is an image application, and the computer readable program code means in said computer program product further comprising computer readable program code means for causing a computer to effect processing means to process said image application, wherein:
said Host Processor loads Sequence Processor Instruction Store with an initial program.
said Host Processor breaks said overall task into sub-tasks to be performed across an entire image;
said Host Processor sets up at least one control block to tell the Sequence Processor particular tasks to perform on the image;
said Host Processor generates an interrupt to the Sequence Processor to tell it to start processing a control block located at a specified starting address in System Memory;
said Sequence Processor fetches a first control block and interprets a specific task to be performed;
said Sequence Processor uses the Data Mover to load the Vector Processor Instruction Store with an appropriate program to perform the specific task;
said Sequence Processor uses the Data Mover to load a first block of data into the Vector Processor Data Store to be processed; and
said Sequence Processor loads the Vector Processor Task Queue with parameters necessary to tell the Vector Processor to start processing.

20. A Vector Coprocessor apparatus as recited in claim 1, further comprising performing processing of sub tasks, wherein:
said Sequence Processor sets up to perform task 1 on Sub block 1 and tells Vector Processor to start processing;
said Sequence Processor sets up to perform task 1 on Sub block 2 and loads task queue as the Vector Processor continues to process;
said Sequence Processor sets up to perform task 1 on Sub block n and loads task queue as the Vector Processor continues to process;
said Sequence Processor sets up to perform task 2 on Sub block 1 and tells Vector Processor to start processing;
said Sequence Processor sets up to perform task 2 on Sub block 2 and loads task queue as the Vector Processor continues to process;
said Sequence Processor sets up to perform task 2 on Sub block n and loads task queue as the Vector Processor continues to process;
said Sequence Processor sets up to perform task m on Sub block 1 and tells Vector Processor to start processing;
said Sequence Processor sets up to perform task m on Sub block 2 and loads task queue as the Vector Processor continues to process;
said Sequence Processor sets up to perform task m on Sub block n and loads task queue as the Vector Processor continues to process.
